(19) United States
(12) Patent Application Publication
(10) Pub. No.: US 2003/0023915 A1
(43) Pub. Date: Jan. 30, 2003

(54) Forward error correction system and method for packet based communication systems

(75) Inventor: Sunghyun Choi, Montvale, NJ (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/918,163

(22) Filed: Jul. 30, 2001

(51) Int. Cl. H04L 1/18; G08C 25/02

(52) U.S. Cl. 714/748

(57) ABSTRACT

Disclosed is a system and method for providing recovery of lost payload blocks in a packet switch network in which a sequence of packets having a number of payload blocks are transmitted from a source node to a destination node. The recovery process determines whether at least one of the payload blocks within a particular packet is lost during transmission; stores other payload blocks that are successfully received within the particular packet in a storage medium for subsequent retrieval; transmits a request for retransmission of the particular packet containing said lost payload block to the source node; and, combines the stored payload blocks with the lost payload block(s) that are retrieved from the subsequent transmission in sequential order.

### BACKGROUND OF THE INVENTION

1. Field of the Invention

The present invention relates to error handling in communication systems. More particularly, the present invention relates to a method and system for handling error correction using automatic retransmission requests (ARQ) in digital communication systems that support multiple FEC coding schemes.

2. Description of the Invention

In a typical packet switched network, a message is divided into a number of data packets or blocks of fixed or variable length. These packets are sent individually over the network through multiple locations, then reassembled at the receiving end before being delivered to an intended user. To ensure proper transmission of the blocks at the receiving end, various control data, including sequence, verification, and error correction information, is typically appended to each packet in the form of a packet header.

The IEEE 802.11 standard specifies the medium access control (MAC) and the physical (PHY) characteristics for wireless local area networks. The IEEE 802.11 standard is defined in International Standard ISO/IEC 8802-111, “Information Technology—Telecommunications and information exchange area networks,” 1999 Edition, which is hereby incorporated by reference in its entirety. The IEEE 802.11e MAC protocol defines an optional MAC Forward Error Correction (FEC) for a more reliable transmission of data frames. The MAC FEC protocol can be used in conjunction with a delayed acknowledgment (DlyAck) scheme, which is different from the conventional acknowledgment (ACK) scheme defined in the IEEE 802.11 MAC specification. The conventional ACK scheme enables the receiver of a frame to send an ACK frame after a successful reception of the frame. However, the delayed ACK scheme is provided so that the receiver can send an ACK frame sometime after the successful frame reception. The delayed ACK scheme is defined particularly due to the heavy computation requirement for the MAC FEC decoding. Currently, the IEEE 802.11 MAC does not have the FEC scheme. Accordingly, the present invention proposes a new FEC mechanism that can be implemented in the IEEE 802.11 environment.

### SUMMARY OF THE INVENTION

The present invention is directed to a method and system for providing a FEC mechanism between a source system and a destination system.

According to an aspect of the present invention, a method for enabling recovery of lost payload blocks includes: transmitting a sequence of packets from a source node to a destination node, each packet in the sequence having a plurality of payload blocks; determining whether at least one of the plurality of the payload blocks within a particular packet is lost during transmission; storing other payload blocks that are successfully received within the particular packet in a storage medium for subsequent retrieval; subsequently transmitting a request for retransmission of the particular packet containing the lost payload block; and, combining the stored payload blocks with the lost payload block that is retrieved from the subsequent transmission in sequential order.

According to anther aspect of the invention, a system for enabling recovery of lost payload blocks in a packet switch network includes: a demodulator configured to receive and demodulate a modulated signal to generate a sequence of demodulated packets, each packet in the sequence having a predetermined number of payload blocks; a decoder operatively coupled to the demodulator for decoding the demodulated packets into a plurality of decoded frames; a processor coupled to the decoder and configured to receive and check the plurality of decoded frames to identify a number of erroneously received payload blocks within a particular decoded frame; a storage means for storing other payload blocks that are successfully received within a particular frame in a storage medium for subsequent retrieval; a transmitter for subsequently transmitting a request for the retransmission of the particular frame with the erroneously received blocks; and, a combiner for combining the stored payload blocks with the erroneously received payload block retrieved from the subsequent transmission in sequential order.

These and other advantages will become apparent to those skilled in the art upon reading the following detailed description in conjunction with the accompanying drawings.

### BRIEF DESCRIPTION OF THE DRAWINGS

FIG. 1 is a representation of a MAC frame format that is used to exchange information as set forth in the proposed IEEE 802. 11e standard;

FIG. 2 is a simplified block diagram of the receiver that may utilize the error correction control scheme in accordance with the present invention;

FIG. 3 is a graphic illustration of the operation steps in accordance with the present invention; and,

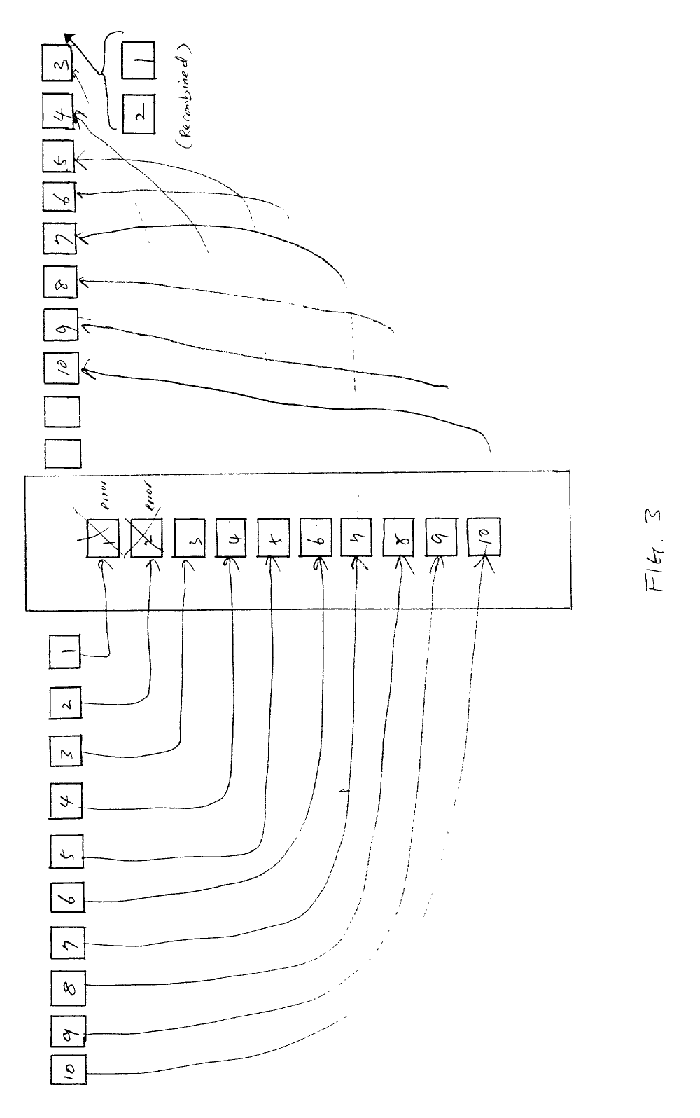

FIG. 4 is a flow chart illustrating the operation steps in accordance with the present invention.

### DETAILED DESCRIPTION OF THE PREFERRED EMBODIMENT

In the following description, for purposes of explanation rather than limitation, specific details are set forth such as the particular architecture, interfaces, techniques, etc., in order to provide a thorough understanding of the present invention. In addition, for purposes of clarity and simplicity detailed descriptions of well-known devices, circuits, and methods are omitted so as not to obscure the description of the present invention with unnecessary detail.

The present invention relates to an error correction mechanism that enables the recovery of lost data packets within specified limits, while minimizing the overhead associated with the conventional FEC scheme. In particular, the present invention is applicable to a digital communication system, which complies with the IEEE 802.11 standard. The IEEE 802.11e defines an optional MAC FEC scheme, in which data packets are encoded using well-known Reed-Solomon (RS) class of codes. This service provides entities with the ability to exchange MAC service data units (MSDUs) by utilizing the underlying PHY-level services.

Currently, the conventional error recovery scheme under the IEEE 802.11e provides that each block, after demodulation and FEC decoding, be evaluated for errors using the block check sequence and well known cyclic redundancy check techniques. If there are errors after FEC decoding, then a request is sent back to the transmitting entity for retransmission. To this end, both the transmitting and receiving entities need to know what combination of FEC coding and/or modulation schemes are being used for retransmission. However, in the preferred embodiment, rather than employing a request and retransmission system, greater efficiency in packet loss correction may be achieved by reusing correctly-received RS code blocks to combine with other correctly-received RS code blocks in the retransmitted version of the same frame.

In addition to the FEC and modulation schemes, digital communication systems according to the present invention employ automatic retransmission request (ARQ) techniques, which enable the erroneously received information to be retransmitted to the receiver. ARQ techniques involve analyzing received blocks of data for error and requesting retransmission of blocks, which contain any error. The FEC techniques include, for example, convolutional or block coding of the data prior to modulation. It is common to refer to convolutional codes by their code rates, i.e., ½ and ⅓, wherein the lower code rates provide greater error protection but lower user bit rates for a given channel bit rate. Hence, the FEC coding involves representing a certain number of data bits using a certain number of code bits. It should be noted that the FEC techniques are well known to those skilled in this art.

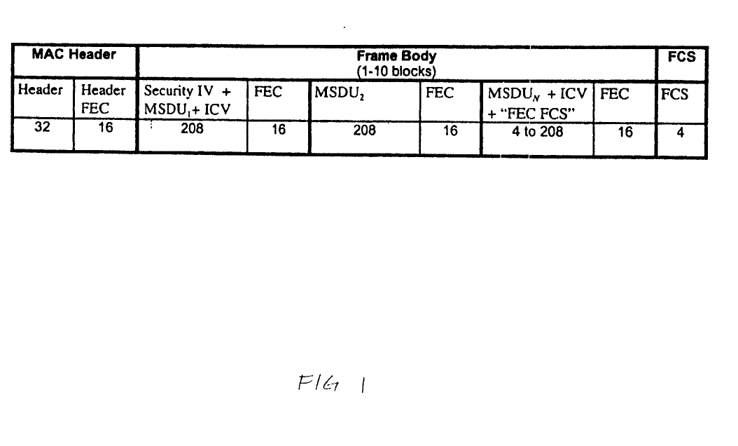

FIG. 1 illustrates the RS-encoded MAC Protocol Data Unit (MPDU) frame format that has been proposed in the IEEE 802.11e. As shown in FIG. 1, the RS codec is used for the MAC FEC scheme. As an MSDU can be much larger than 208 bytes, the MSDU may be split up to 10 blocks, wherein each block is encoded independently by the RS encoder. For the purpose of this example, the encoder employed by the invention is an RS block coder having (n, k) values of (224, 228). Thus, for every MSDU payload block in the incoming sequence, the coder derives a FEC code or redundancy blocks. According to the invention, the encoder then appends these redundancy blocks, respectively, to each payload block. To facilitate decoding in the preferred embodiment, a packet that is transmitted according to the present invention preferably includes indications of the sequence number or packet number, the (n, k) values It is noted the payload/data length, the playload/data block information in the MAC header field. It will be apparent to those skilled in the art that other data structures from the one shown can be successfully used, including but not limited to fields of different size, arranging the fields in different order, and additional fields not present in FIG. 1.

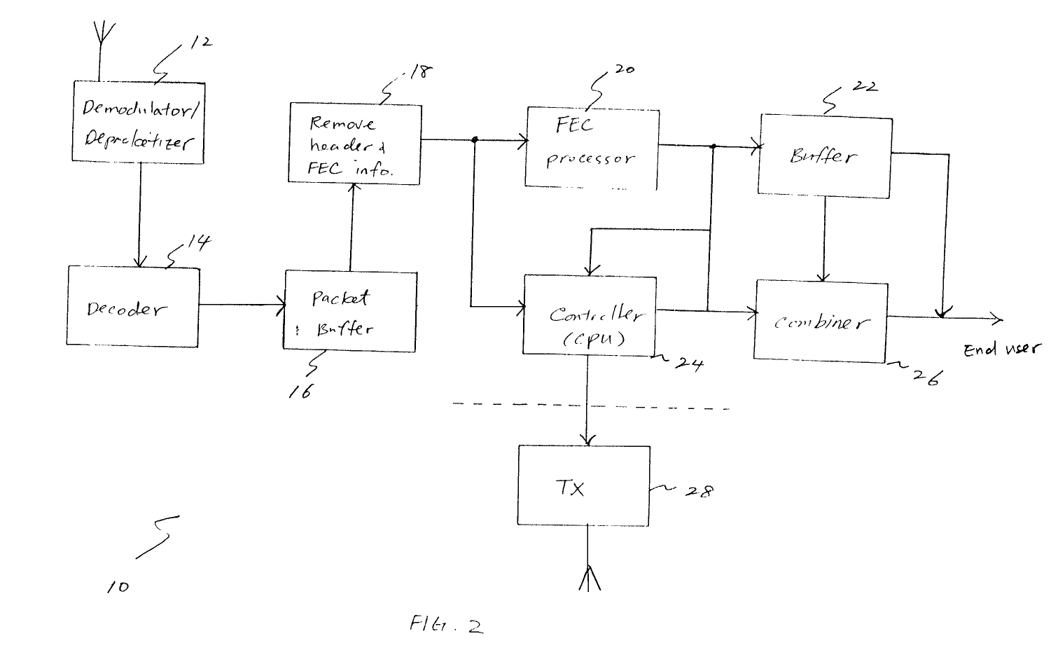

FIG. 2 illustrates a decoder 10 operating in accordance with a preferred embodiment of the present invention. For purposes of illustration, the following description will assume that an audio or video signal has been converted into a digital data stream and is to be transmitted in a network from a source node to a destination node. The description will further assume by way of example that the digital data stream, or payload, has been divided into a sequence of frames or payload packets. According to the embodiment of the present invention, the decoder 10 includes a demodulator (or depacketizer) 12, a decoder 14, a packet buffer 16, a header and FEC removal processor 18, a FEC processor 20, a controller 24, a buffer 22, a combiner module 26, and a transmitter 28.

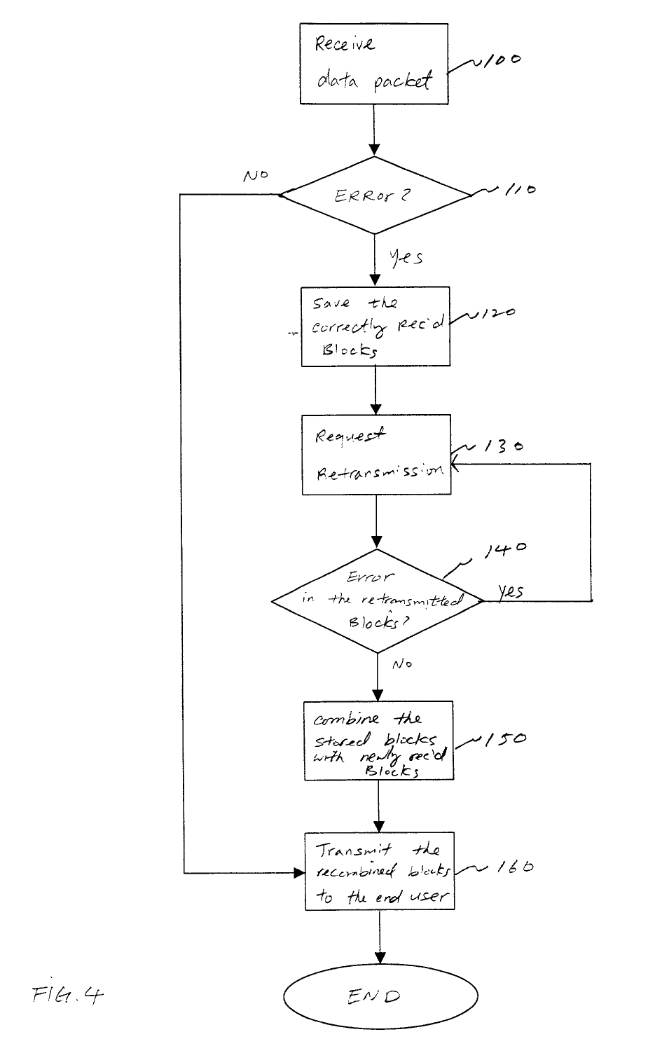

In operation, a stream of packets, as shown in FIG. 1, arrive at the destination node. Depending on the packet switching protocol in use, these packets may arrive in sequential order or out of order. The decoder 14 receives the demodulated datablocks from the demodulator 12 and reconstructs the sequence of datablocks, then the sequence of datablocks are provided to the packet buffer 16 as individual datablocks. Thereafter, the header and FEC removal processor 18 operate to remove the MAC header information and examine the header information to determine whether the datablock should be processed, and what type of error-correction decoding may be employed by the datablock stored in the packet buffer 16. The FEC processor 20, under the control of the controller 24, performs the error-correction operation. If an error is detected, the controller 24 causes the transmitter 28 to request the retransmission of the error packets to the source end system. At the same time, those payload blocks that arrived successfully are preferably forwarded directly to the buffer 22 for subsequent retrieval, which serves to put the payload blocks in proper sequence for receipt by an end user. Here, the number of blocks stored in buffer 22 may depend on the (n, k) values of the block coder originally used for encoding. After receiving the retransmission of data, the controller 24 performs the demodulation and FEC operations, as described in the preceding paragraphs, and then determines whether the retransmitted data can help recover missing information. For example, as shown in FIG. 4, if a source node transmits a frame with 10 RS blocks (from block 1 to block 10) to a destination node, the destination node may find that blocks 1 and 2 are not correctable. The destination node transmits a DlyAck to the source node for retransmission and caches the successively received blocks 3 to 10, instead of discarding them. Then, the source transmits the requested frame again. The destination node now determines that there are errors in blocks 9 and 10, which are not correctable. As the destination node has stored the correct versions of blocks 9 and 10 from the original reception, it does not need to inform the source node of the incorrect frame reception (blocks 9 and 10). By combining blocks 3 and 10 from the original reception with blocks 1 and 2 from the new reception, the whole frame can be reconstructed correctly. Once the decoder 10 recovers the missing payload block 1 and 2 and combines with the remaining blocks stored in the buffer 22 in sequential order, the controller 24 forwards the ordered payload to the end user. As a result, the retransmission combining according to the present invention can improve the system performance significantly depending on the channel condition by reducing the number of potential retransmission. In addition, the probability to meet the latency requirement in a marginal channel condition is increased as it will require a smaller number of retransmission to transmit a frame successfully.

While a decoder operating in accordance with the present invention may take any of a variety of forms (such as hardware, software, or firmware), both the encoding and decoding functions are preferably carried out by a computer processor or microprocessor operating a set of machine language instructions that are stored in a memory. Such computer programs, when executed, enable the computer system to perform the function of the present invention as discussed herein. FIG. 4 is a flow diagram illustrating the processing performed by the present invention to provide user recommendation. The rectangular elements indicate computer software instruction, whereas the diamond-shaped element represents computer software instructions that affect the execution of the computer software instructions represented by the rectangular blocks.

Referring to FIG. 4, a stream of data is received at the destination node in step 100. The decoder 10 examines the received data packets and determines whether uncorrectable packets are detected in step 110. If so, the decoder 10 saves the correctly-received blocks in the incorrectly received packets in the buffer 22 for subsequent retrieval in step 120. At the same time, the decoder 10 requests retransmission of the data packets again in step 130. If error blocks found in step 110 still contain error in step 140, the request for retransmission of the same data packets is sent again. If not, the error data packets found in step 110 are retrieved from the retransmitted data packets and combined with the remainder of the correctly received blocks stored in the buffer 22 in step 150. Finally, the recombined data packets in sequential order are transmitted to the end user in step 160.

As is apparent from the foregoing, the present invention has an advantage in that the decoder 10 can minimize the need to make repetitious requests for retransmission of lost packets, thereby minimizing the overhead associated with the number of potential retransmission requests. It should be noted that the previous description of the preferred embodiments is provided to enable any person skilled in the art to make or use the present invention. The various modifications to these embodiments will be readily apparent to those skilled in the art, as well as other embodiments, without the use of the inventive faculty. Thus, the present invention is not intended to be limited to the embodiments shown herein but is to be accorded the widest scope consistent with the principles and novel features disclosed herein.

What is claimed:

1. A method for enabling recovery of lost payload blocks, the method comprising the steps of:
(a) transmitting a sequence of packets from a source node to a destination node, each packet in said sequence having a plurality of payload blocks;
(b) determining whether at least one of the plurality of said payload blocks within a particular packet is lost in said transmission;
(c) storing other payload blocks that are successfully received within said particular packet in a storage medium for subsequent retrieval;
(d) subsequently transmitting a request for retransmission of said particular packet containing said lost payload block to said source node; and,
(e) combining said stored payload blocks with said lost payload block retrieved from said subsequent transmission in sequential order.

2. The method of claim 1, further comprising the step of monitoring link quality associated with the at least one of the plurality of said payload blocks.

3. The method of claim 1, further comprising the step of counting a number of erroneously received payload blocks during said transmission.

4. The method of claim 1, wherein said step (b) further comprises the step of performing error-correction to recover said lost payload blocks.

5. The method of claim 4, wherein if said error-correction fails, performing said steps (c) through (e).

6. The method of claim 1, wherein said step (d) further comprises the step of retrieving said lost payload block from said subsequent transmission.

7. The method of claim 1, wherein said step (d) further comprises the steps of:
determining whether the payload block corresponding to said lost payload from said subsequent transmission is received successfully;
if yes, performing said step (e); and,
if no, requesting for retransmission of said particular packet containing said lost payload block again.

8. A method for enabling recovery of lost payload blocks, the method comprising the steps of:
(a) receiving a sequence of encoded signals by a destination node from a source node;
(b) decoding each received signal in accordance with a particular decoding format to generate a plurality of decoded frames, each decoded frame having a plurality of payload blocks;
(c) examining the plurality of decoded frames to identify a number of erroneously received payload blocks within a particular decoded frame;
(d) storing other payload blocks that are successfully received within said particular frame in a storage medium for subsequent retrieval;
(e) subsequently transmitting a request for retransmission of said particular frame with said erroneously received blocks; and,
(f) combining said stored payload blocks with said erroneously received payload block retrieved from said subsequent transmission in sequential order.

9. The method of claim 8, further comprising the step of demodulating the encoded signals in accordance with a particular demodulation format to generate the plurality of said decoded frames.

10. The method of claim 8, wherein the demodulation format is specified by the IEEE 802.11 standard.

11. The method of claim 8, wherein encoded signals include employing a Reed-Solomon block coder.

12. The method of claim 8, further comprising the step of performing error-correction to recover said erroneously received payload blocks.

13. The method of claim 8, wherein if said error-correction fails, performing said steps (d) through (f).

14. The method of claim 8, wherein said step (e) further comprises the steps of:
determining whether the payload block corresponding to said lost payload from said subsequent transmission is received successfully;
if yes, performing said step (f); and,
if no, requesting for retransmission of said particular packet containing said lost payload block again.

15. An apparatus for enabling recovery of lost payload blocks in a packet switch network in which a sequence of packets is transmitted from a source node to a destination node, each packet in said sequence containing a number of payload blocks, comprising:
a memory;
a processor;
a set of machine language instructions stored in said memory and executed by said processor, said processor configured to:
determine whether at least one of the plurality of said payload blocks within a particular packet is lost in said transmission;
store other payload blocks that are successfully received within said particular packet in a storage medium for subsequent retrieval;
subsequently transmit a request for retransmission of said particular packet containing said lost payload block to said source node; and,
combine said stored payload blocks with said lost payload block retrieved from said subsequent transmission in sequential order.

16. The apparatus of claim 15, wherein the apparatus is included within a telecommunication receiver of a wireless network.

17. A system for enabling recovery of lost payload blocks in a packet switch network, comprising:
a demodulator configured to receive and demodulate a modulated signal to generate a sequence of demodulated packets, each packet in said sequence having a predetermined number of payload blocks;
a decoder operatively coupled to said demodulator for decoding said demodulated packets into a plurality of decoded frames;
a processor coupled to said decoder for examining the plurality of decoded frames to identify a number of erroneously received payload blocks within a particular decoded frame;
a storage means for storing other payload blocks that are successfully received within a particular frame for subsequent retrieval;
means for subsequently transmitting a request for the retransmission of said particular frame having said erroneously received blocks; and,
means for combining said stored payload blocks with said erroneously received payload block retrieved from said subsequent transmission in sequential order.

18. The system of claim 17, further comprising an error-correction means for performing error-correction to recover said erroneously received payload blocks.

19. The method of claim 17, wherein the demodulation format is specified by the IEEE 802.11 standard.
